(19) United States
(12) Patent Application Publication
(10) Pub. No.: US 2005/0131605 A1
(43) Pub. Date: Jun. 16, 2005

(54) Occupant sensing system

(75) Inventors: Masahiro Nakamoto, Tokyo (JP); Satoru Inoue, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/003,704

(22) Filed: Dec. 6, 2004

(30) Foreign Application Priority Data
Dec. 12, 2003 (JP) 2003-415318

(51) Int. Cl. B60R 22/00

(52) U.S. Cl. 701/45

(57) ABSTRACT

Load fluctuation operating section calculates fluctuant quantities of each of a total load value and a partial load value respectively calculated by a load operating section based on the sensed load value, and determines whether or not the total load fluctuating quantity and the partial load fluctuating quantity are on the increase or on the decrease to obtain a total load fluctuating direction and a partial load fluctuating direction. An occupant-type changeover permitting signal indicative of permission of the occupant-type changeover is output only when the total load fluctuating quantity is more than the previously defined first threshold, the partial load fluctuating quantity is more than another threshold differing from the first threshold, and the total load fluctuating direction and the partial load fluctuating direction show the same fluctuation tendency.

### BACKGROUND OF THE INVENTION

1. Field of the Invention

The present invention relates to an occupant sensing system that senses what sort of occupant has taken a vehicle seat of a vehicle according to a load applied to the seat.

2. Description of the Related Art

In general, some vehicles have an occupant sensing system determining what sort of occupant has had a vehicle seat (e.g., determining whether or not the occupant is an adult or a child, or the seat is vacant) in order to bring, e.g., an airbag or equivalents into a ready state (deployment permission) based on the determined result.

In such an occupant sensing system, a load applied to the vehicle seat is sensed to determine an occupant type according to the sensed load. However, the sensed load can vary depending on how an occupant is sitting in the seat and how a vehicle is moving, and undergoes a frequent change of determination of an occupant type due to fluctuations of the sensed load. That is, it finds difficulty in determining an occupant type with accuracy because of a disturbance caused by the above noted fluctuant factors, i.e., a sitting posture of an occupant and driving conditions. As a result, e.g., although just the same person is sitting in the seat as an occupant, it is not seldom that there happens a situation where an indication of permission or prohibition of an airbag deployment often changes against one's will.

In order to rectify the deficiencies, JP 2001-074541 A (Paragraph (0030) to Paragraph (0052), and FIG. 1 to FIG. 4.) discloses, e.g., an occupant sensing system arranged such that when a sensed weight value is more than a predetermined first threshold, the weight is judged as being in a heavy class. Thereafter, the determinant of the heavy class will be maintained until the sensed weight value is less than a second threshold smaller than the first threshold. Then, after the sensed weight value is less than the second threshold and the weight is judged as being in a light class, the determinant of the light class will be maintained until the sensed weight value is more than the first threshold. Herein, it is not rare for a mean value of the sensed weight value measured over a predetermined period to be used in place of the sensed weight value.

Moreover, JP 2002-357476 A (Paragraph (0037) to Paragraph (0084), and FIG. 1 to FIG. 4) discloses, e.g., an occupant sensing system arranged such that when an occupant took a seat, weight thereof is quickly measured with good responsiveness. After that, the system is less sensitive to fluctuations even if weight fluctuations occur. Herein, determination of an occupant type is carried out in the following way. Weight (sensed weight) of an occupant sitting in the seat is input to a load responding system, and filtered through a filter to obtain a measured load. In the load responding system, a response speed of the filter is changed based on a response speed changing signal determined depending on a fluctuation of the sensed weight, and the sensed weight processed at a different response speed of the filter is output as a measured load.

In that the conventional occupant sensing system is arranged as mentioned above, a response is substantially delayed to prevent the determination of the occupant type from being temporarily changed even if the sensed body weight value (sensed weight) is fluctuated by lurches while running and an occupant's posture, the occupant type could be nevertheless falsely judged as being the same in spite of the fact that the occupant type is actually changed attributable to the delayed response. Consequently, one encounters with a difficulty in sensing an occupant type with accuracy.

The increased response speed of the determination of the occupant type might give rise to make a false determinant as the occupant type is being changed every time lurches are given while running and an occupant's posture changes. Also in this case, it gets into difficulty in determining an occupant type with accuracy.

### SUMMARY OF THE INVENTION

The present invention has been made to solve the above-mentioned problems. An object of the present invention is to provide an occupant sensing system able to determine an occupant type changeover with accuracy even if a vehicle gives lurches while running and an occupant's posture changes.

The occupant sensing system according to the present invention determines an occupant type changeover in the following manner, i.e., when a load applied to a vehicle seat is sensed as a sensed load value to determine what sort of occupant is sitting in a vehicle seat based on the sensed load value, the system calculates at least a total load value applied to the whole vehicle seat, and calculates a load value applied to a portion of the vehicle seat as a partial load value based on the sensed load value. Moreover, the system calculates fluctuating quantities based on the total load value and the partial load value as a total load fluctuating quantity and a partial load fluctuating quantity, respectively, and determines whether or not the total load fluctuating quantity and the partial load fluctuating quantity are on the increase or on the decrease to thereby determine a total load fluctuating direction and a partial load fluctuating direction; and thereafter the system outputs an occupant-type changeover permitting signal indicative of permission of an occupant type changeover only when the total load fluctuating quantity is more than the previously defined first threshold, the partial load fluctuating quantity is more than another threshold differing from the first threshold, and the total load fluctuating direction and the partial load fluctuating direction show the same fluctuation tendency.

Therefore, according to the present invention, it allows determination of an occupant type changeover with accuracy even if a vehicle gives lurches while running and an occupant's posture changes.

### BRIEF DESCRIPTION OF THE DRAWINGS

FIG. 1 is a block diagram showing an example of an occupant sensing system according to the present invention;

FIG. 2 is a flow chart explaining an example of an operation of the occupant sensing system according to a first embodiment;

FIGS. 3A, 3B, and 3C are graphs showing the relationship between load values and reference values in the occupant sensing system shown in FIG. 1; FIG. 3A is a graph showing the relationship between a total load value and a total load reference value; FIG. 3B is a graph showing the relationship between a front load value and a front load reference value; and FIG. 3C is a figure showing the relationship between a rear load value and a rear load reference value;

FIG. 4 is a view explaining an occupant type determining threshold used in the occupant sensing system shown in FIG. 1;

FIG. 5 is a graph showing an example of an occupant-type changeover permitting and prohibiting signal produced in the occupant sensing system shown in FIG. 1; and

FIG. 6 is a flow chart explaining another example of an operation of the occupant sensing system according to a first embodiment.

### DETAILED DESCRIPTION OF THE PREFERRED EMBODIMENTS

A preferred embodiment of the present invention will now be described below with reference to the accompanying drawings.

### First Embodiment

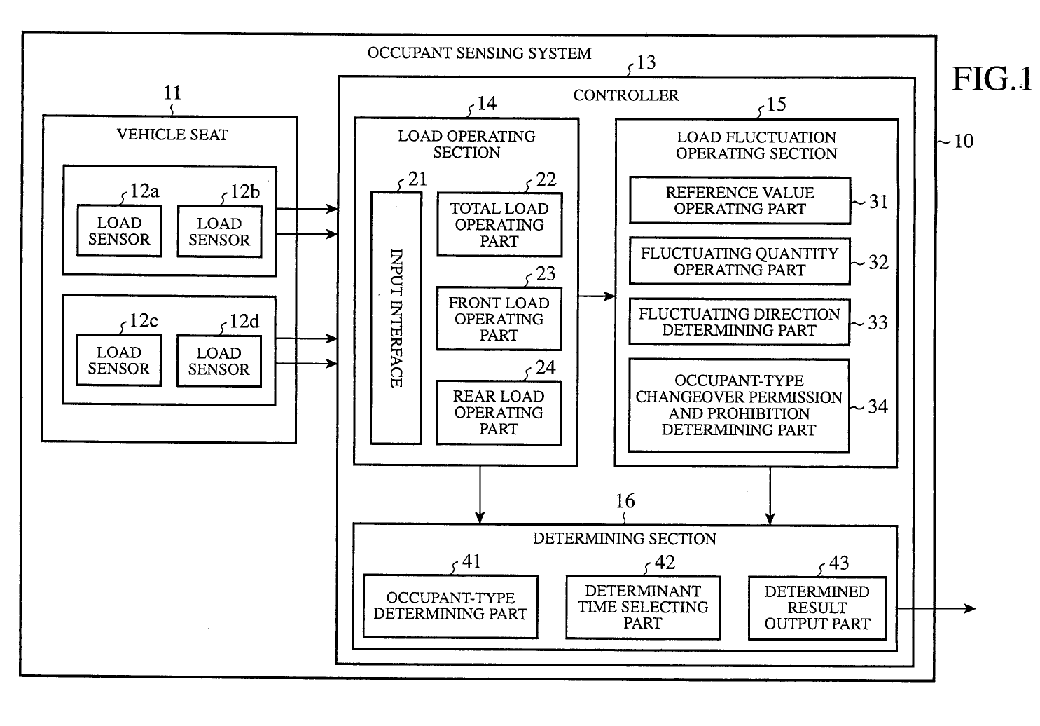

FIG. 1 is a block diagram showing an occupant sensing system according to the first embodiment for embodying the present invention. In FIG. 1, the occupant sensing system 10 shown in FIG. 1 is mounted on a vehicle, and, e.g., an airbag deployment permission and prohibition state is changed based on the determined result of an occupant type executed by the occupant sensing system 10. It should be understood that the term “occupant type” is for discriminating whether or not a vehicle seat is, e.g., vacant or is occupied by a child, or by an adult. The occupant sensing system 10 is provided with first to fourth load sensors 12a to 12d attached to a vehicle seat 11. Among those sensors, the first and second load sensors 12a and 12b are disposed left and right at a predetermined interval ahead (in the front of) of the vehicle seat 11, and the third and fourth load sensors 12c and 12d are disposed left and right at a predetermined interval at the rear (in the rear of) of the vehicle seat 11.

The load sensors 12a to 12d are connected to a controller 13, and the controller 13 includes a load operating section (load operating means) 14, a load fluctuation operating section (load fluctuation operating means) 15, and a load determining section (load determining means) 16. The load operating section 14 is provided with an input interface 21, a total load operating part (total load operating means) 22, a front load operating part(front load operating means) 23, and a rear load operating part (rear load operating means) 24; the input interface 21 includes a low-pass filter (LPF, not shown) and an AD converter; and the loads sensed by the first to fourth load sensors 12a to 12d (hereinafter, the loads sensed by the first to fourth load sensors 12a to 12d are referred to as the first to fourth sensed loads, respectively) are filtered through a LPF to remove high-frequency components (e.g., noises), and they are converted into digital values by the AD converter.

The total load operating part 22 sums up the first to fourth sensed loads to obtain a total load value. Similarly, the front load operating part 23 sums up the first and second sensed loads to obtain a front load value. Further, the rear load operating part 24 sums up the third and fourth sensed loads to obtain a rear load value. These total load value, front load value, and rear load value are given to the load fluctuation operating section 15. Herein, the front load value and the rear load value constitute a partial load value.

The load fluctuation operating section 15 is provided with a reference value operating part (reference value operating means) 31, a fluctuation quantity operating part (fluctuation quantity operating means) 32, a fluctuating direction determining part (fluctuating direction determining means) 33, and an occupant-type changeover permission and prohibition determining part (occupant-type changeover permission and prohibition determining means) 34. In the reference value operating part 31, the total load value, the front load value, and the rear load value filtered through the LPF to produce a total load reference value, a front load reference value, and a rear load reference value, respectively (LPF processing in the reference value operating part 31 is performed at a response speed lower than that in the input interface 21).

The fluctuation quantity operating part 32 makes a comparison between the total load value and the total load reference value, between the front load value and the front load reference value, and between the rear load value and the rear load reference value to obtain respective fluctuant quantities as a total load fluctuating quantity, a front load fluctuating quantity, and a rear load fluctuating quantity, respectively (front load fluctuating quantity and the rear load fluctuating quantity constitute a partial load fluctuating quantity). Likewise, the fluctuating direction determining part 33 makes a comparison between the total load value and the total load reference value, between the front load value and the front load reference value, and between the rear load value and the rear load reference value to determine whether or not the respective fluctuant quantities are on the increase or on the decrease (hereinafter referred to as a fluctuating direction) to obtain the total load fluctuating direction, the front load fluctuating direction, and the rear load fluctuating direction (front load fluctuating direction and the rear load fluctuating direction constitute a partial load fluctuating direction).

Then, the occupant-type changeover permission and prohibition determining part 34 outputs, in a manner as will be described later, an occupant-type changeover permitting and inhibiting signal indicating whether or not an occupant type changeover is permitted based on the total load fluctuating quantity, the front load fluctuating quantity, and the rear load fluctuating quantity; and the total load fluctuating direction, the front load fluctuating direction, and the rear load fluctuating direction.

The determining section (determining means) 16 is given the total load value and the occupant-type changeover permitting and inhibiting signal, and which includes an occupant-type determining part (occupant-type determining means) 41, a determinant time selecting part (determinant time selecting means) 42, and a determined result output part (determined result output means) 43. The determinant time selecting part 42 selects, in a fashion as will be described later, either of an occupant-type changeover permission determinant time and an occupant-type changeover prohibition determinant time as a selected determinant time according to the occupant-type changeover permitting and prohibiting signal. The occupant-type determining part 41 determines, in a manner as will be described later, the occupant type according to the total load value, and when the determined result of the occupant type lasts during the selected determinant time, the occupant-type determining part changes the occupant type to the determined result of the occupant type.

In addition, the determined result of the occupant type is given from the determined result output part 43 to, e.g., an airbag controller (an airbag ECU (electronic control unit), not shown). The airbag ECU brings an airbag into a deployment permission state or a deployment prohibition state depending on the determined result of the occupant type.

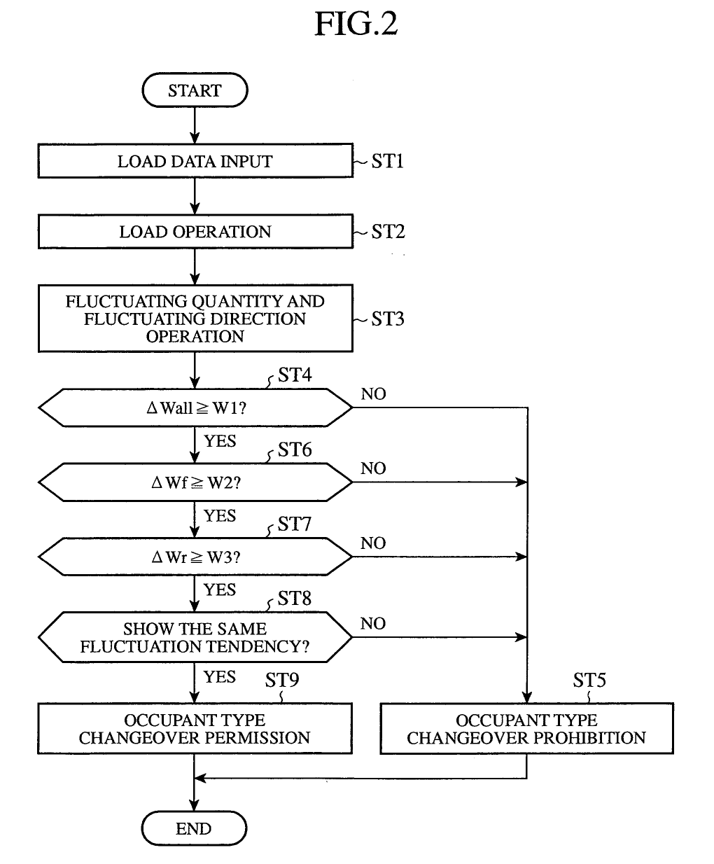

The operation will now be described with reference to FIG. 1 and FIG. 2.

When the occupant sensing system is turned on (activated), the first to fourth load sensors 12a to 12d give the first to fourth sensed loads to the load operating section 14 as described above (load data input: step ST1). Then, the load operating section 14 calculates the total load value, the front load value, and the rear load value as described above (load calculation: step ST2). The load fluctuation quantity operating part 32 and the fluctuating direction determining part 33 calculate the total load fluctuating quantity, the front load fluctuating quantity, and the rear load fluctuating quantity; and the total load fluctuating direction, the front load fluctuating direction, and the rear load fluctuating direction (calculations of the fluctuating quantity and fluctuating direction: step ST3).

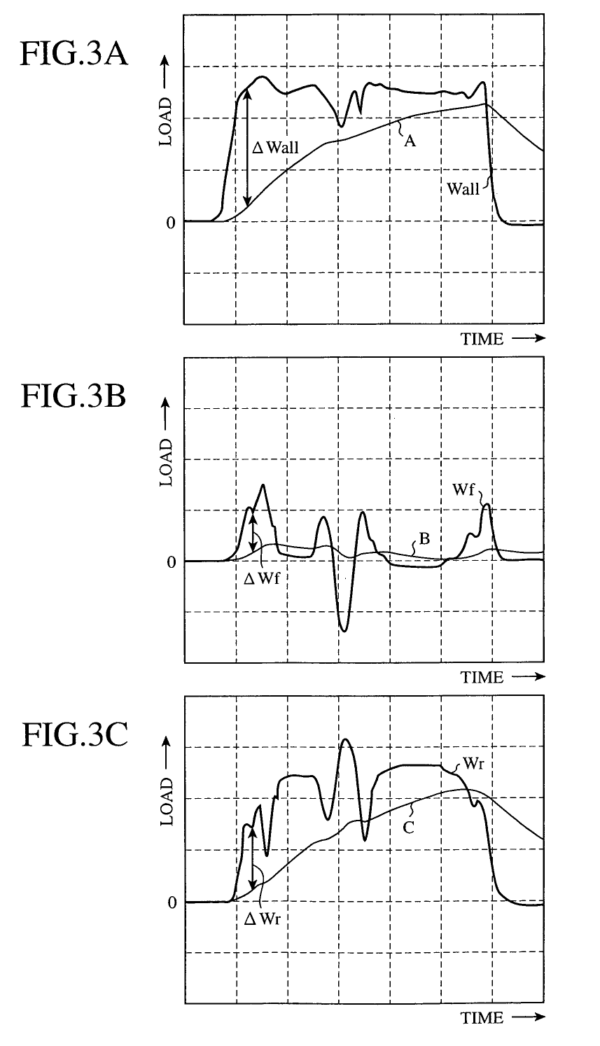

Referring now to FIG. 3A, FIG. 3B, and FIG. 3C, the total load reference value obtained by filtering the total load value through the LPF fluctuates with time as indicated by reference character “A” in FIG. 3A, given that the total load value fluctuated with time as indicated by reference character “Wall” in FIG. 3A. The portion indicated by “Fluctuating quantity ΔWall” in FIG. 3A represents the total load fluctuating quantity. Similarly, the front load reference value obtained by filtering the front load value through the LPF fluctuates with time as indicated by reference character “B” in FIG. 3B, given that the front load value fluctuated with time as indicated by reference character “Wf” in FIG. 3B. The portion indicated by “Fluctuating quantity ΔWf” in FIG. 3B represents the front load fluctuating quantity. Further, the rear load reference value obtained by filtering the rear load value through the LPF fluctuates with time as indicated by reference character “C” in FIG. 3C, given that the rear load value fluctuated with time as indicated by reference character “Wr” in FIG. 3C. The portion indicated by “Fluctuating quantity ΔWr” in FIG. 3C represents the rear load fluctuating quantity.

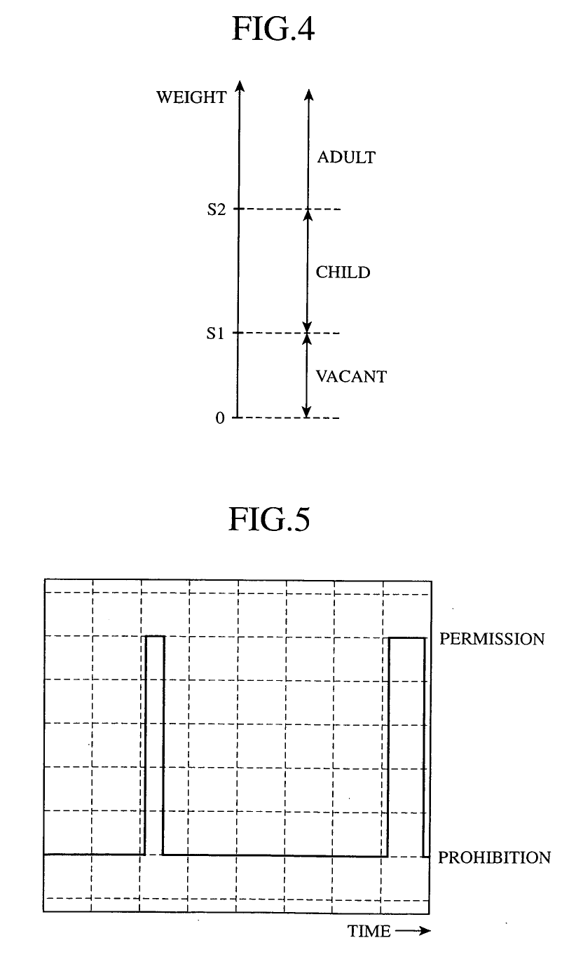

In the occupant-type changeover permission and prohibition determining part 34, a plurality of occupant type thresholds are set depending on occupant's weights. For example, as shown in FIG. 4, the occupant type threshold S1 used for distinguishing whether or not a vehicle seat is occupied by a child and an occupant type threshold S2 used for distinguishing whether or not a vehicle seat is occupied by a child or by an adult. If assuming that the occupant type threshold S1 is a first threshold, second and third thresholds are additionally set in the occupant-type changeover permission and prohibition determining part 34. The second and the third thresholds correspond to the front load value and the rear load value, respectively. Where there is the relationship as follows: the second threshold<the third threshold<the first threshold, and the first threshold=the second threshold+the third threshold (the reason why the relationship of the second threshold<the third threshold is established is because a larger load is applied to the rear portion of the seat than on the front portion of the seat when an occupant sits in the seat)

In the occupant-type changeover permission and prohibition determining part 34, the second and third thresholds are set with the occupant type threshold S1 as the first threshold.

As previously stated, when the occupant-type changeover permission and prohibition determining part 34 received the total load fluctuating quantity, the front load fluctuating quantity, and the rear load fluctuating quantity; and the total load fluctuating direction, the front load fluctuating direction, and the rear load fluctuating direction, the determining part determines at first whether or not there is a relationship of the total load fluctuations ΔWall≧the first threshold W1 (step ST4). Then, if ΔWall≧the determining part outputs an occupant-type changeover permission signal indicative of permission of an occupant type changeover (step ST5). Otherwise, if ΔWall≧W1, the determining part 34 subsequently determines whether or not there is a relationship of the front fluctuating quantity ΔWf≧the second threshold W2 (step ST6). If ΔWf<W2, the determining part executes the step ST5.

In the step ST6, if ΔWf≧W2, the determining part 34 subsequently determines whether or not there is a relationship of the rear load fluctuating quantity ΔWr≧the third threshold W3 (step ST7). Then, if ΔWr<W3, the step ST5 is executed. Otherwise, if ΔWr≧W3, the determining part 34 determines whether or not the total load fluctuating direction, the front load fluctuating direction, and the rear load fluctuating direction show the same fluctuation tendency (i.e., whether or not the total load fluctuating direction, the front load fluctuating direction, and the rear load fluctuating direction are all on the increase or on the decrease) (step ST8). If all the fluctuating directions show the same fluctuation tendency, the determining part outputs an occupant-type changeover permitting signal indicative of permission of an occupant type changeover (step ST9). Otherwise, the determining part 34 executes the step ST5.

As shown in FIG. 5, when an occupant-type changeover permitting and prohibiting signal indicates permission of an occupant-type changeover (high-level), this signal implies “Permission,” and when the signal indicates prohibition of an occupant-type changeover (low-level), this signal implies “Prohibition”.

As is apparent from the above discussions, the load sensing sensors 12a to 12d serve as the load sensing part, and the reference value operating part 31, the fluctuation quantity operating part 32, and the fluctuating direction determining part 33 act as the fluctuation operating means. Moreover, while in the first embodiment, the four load sensors 12a to 12d are provided, a plurality of load sensors may be provided alternatively to sense the load applied to the vehicle seat 11.

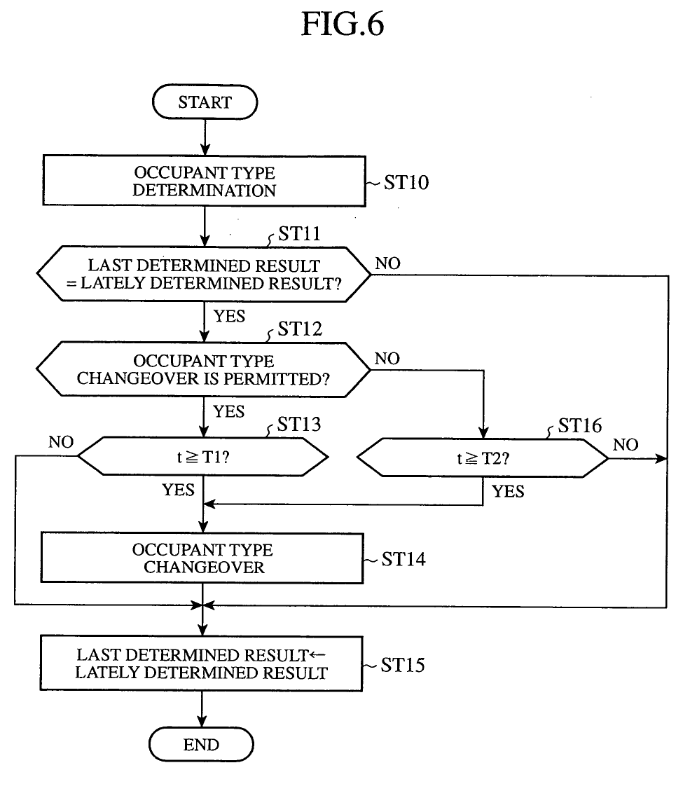

Referring to FIG. 1 and FIG. 6, an explanation of the case where the controller 13 of the occupant sensing system includes the load operating section 14, the load fluctuation operating section 15, and the determining section 16 will now be given below. As mentioned above, the determining section 16 is given a total load value from the load operating section 14, and the determining section 16 is given an occupant-type changeover permitting and prohibiting signal from the load fluctuation operating section 15. In the occupant-type determining part 41, the above-mentioned occupant type thresholds S1 and S2 are set, and the occupant-type determining part 41 compares the total load value with the occupant type thresholds SI and S2 to determine an occupant type of occupant sitting in the seat 11, and obtain a lately determined result (occupant type determination: step ST10).

The occupant-type determining part 41 compares the last determined result obtained from the last occupant type determination carried out in the step ST10 with the lately determined result (step ST11). If the last determined result is equal to the lately determined result, the determinant time selecting part 42 determines whether or not the occupant-type changeover permitting and prohibiting signal explained in FIG. 2 indicates permission of the occupant-type changeover (step ST12). In the determinant time selecting part 42, first and second determinant times T1 and T2 are previously set corresponding to the permission of the occupant type changeover and prohibition of the occupant-type changeover, respectively; and holds the relationship of the first determinant time T1<the second determinant time T2 (e.g., the first determinant time T1=1 second and the second determinant time T2=5 seconds.)

If, in the step ST12, the occupant-type changeover permitting and prohibiting signal indicates permission of the occupant-type changeover, the determinant time selecting part 42 selects the first determinant time T1 as the selected determinant time, and passes the first determinant time T1 to the occupant-type determining part 41. The occupant-type determining part 41 compares the duration t of the lately determined result of the occupant type with the first determinant time T1 (step ST13). If t≧T1, the occupant-type determining part 41 determines that the occupant type is changed, and determines an occupant type (step ST14). Then, the determined result of the occupant type is given to the airbag ECU by the determined result output part 43, and the airbag ECU brings the airbag into a deployment permission state or a deployment prohibition state according to the determined result of the occupant type. Thereafter, the occupant-type determining part 41 stores the lately determined result of the occupant type as the last determined result of the occupant type (step ST15), and finishes the processing. Otherwise, if t<T1 in the step ST13, the processing proceeds to the step ST15, and the occupant-type is not changed.

If, in the step ST12, the occupant-type changeover permitting and prohibiting signal indicates prohibition of the occupant-type changeover, the determinant time selecting part 42 selects the second determinant time T2 as the selected determinant time, and passes the second determinant time T2 to the occupant-type determining part 41. The occupant-type determining part 41 compares the duration t of the lately determined result of the occupant type with the second determinant time T2 (step ST16). If t≧T2, the occupant-type determining part determines that the occupant type is changed, in the step ST14, and the determined result of the occupant type is given to the airbag ECU by the determined result output part 43. After that, the occupant-type determining part 41 stores the lately determined result of the occupant type as the last determined result of the occupant type in the step ST15, and finishes the processing. Otherwise, if t<T2 in the step ST16, the processing proceeds to the step ST15, and the occupant-type is not changed. In addition, if in the step ST11, the last determined result of the occupant type is not equal to the lately determined result of the occupant type, the processing proceeds to the step ST15, and the occupant type is not changed.

Through the structure according to the first embodiment in which the occupant sensing system is arranged such that it involves calculating the total load value applied to the whole vehicle seat based on the sensed load value of the load applied to the vehicle seat, calculating the load value applied to a portion of the whole seat as a partial load value, calculating respective fluctuant quantities based on the total load value and the partial load value as the total load fluctuating quantity and the partial load fluctuating quantity, respectively, determining whether or not the total load fluctuating quantity and the partial load fluctuating quantity are on the increase or on the decrease to thereby find the total load fluctuating direction and the partial load fluctuating direction, and outputting the occupant-type changeover permitting signal indicative of permission of an occupant type changeover only when the total load fluctuating quantity is more than the previously defined first threshold, the partial load fluctuating quantity is more than another threshold differed from the first threshold, and the total load fluctuating direction and the partial load fluctuating direction show the same fluctuation tendency, the system allows determination of the occupant type with accuracy even if a vehicle gives lurches while running and an occupant's posture changes.

Further, through the structure according to the first embodiment in which the occupant sensing system is arranged such that it involves calculating the front load value, which is a load value applied to the front of the vehicle seat and the rear load value, which is a load value applied to the rear of the vehicle seat, as the partial load value, calculating respective fluctuant quantities based on the total load value, the front load value, and the rear load value as the total load fluctuating quantity, the front load fluctuating quantity, and the rear load fluctuating quantity, and outputting an occupant-type changeover permitting signal indicative of permission of the occupant-type changeover only when the total load fluctuating quantity is more than the first threshold, the front load fluctuating quantity and the rear load fluctuating quantity are more than the second threshold and the third threshold, respectively, and the total load fluctuating direction, the front load fluctuating direction, and the rear load fluctuating direction show the same fluctuation tendency, the system prevents an error yielded in the determination of the occupant type by load fluctuations traceable to lurches while running and a change in an occupant's posture, thereby enabling determination of the occupant type with accuracy.

Moreover, through the structure according to the first embodiment in which the occupant sensing system is arranged such that it involves selecting either of the first determinant time and the second determinant time differing from each other in response to an occupant-type changeover permitting and prohibiting signal as the selected determinant time, determining the occupant type based on the total load value and the previously defined occupant-type threshold to thereby obtain the determined result of the occupant type, and determining that the occupant type is changed if the determined result of the occupant type lasts over a time period longer than the selected determinant time, the system avoids the situation where permission of the occupant type changeover is not given because of a small total load fluctuating quantity and a small partial load fluctuating quantity (e.g., front load fluctuating quantity and rear load fluctuating quantity), as in the case where the occupant type is changed leisurely.

Furthermore, through the structure according to the first embodiment in which the occupant sensing system is arranged that it involves selecting the first determinant time as the selected determinant time when the occupant type changing signal indicates permission of the occupant type changeover, selecting the second determinant time as the selected determinant time when the occupant type changing signal indicates prohibition of the occupant type changeover; and making the first determinant time shorter than the second determinant time, the system permits a prompt occupant type changeover when the occupant type changing signal indicates permission of the occupant type changeover.

1. An occupant sensing system that senses a load applied to a vehicle seat as a sensed load value, and that determines what sort of occupant is sitting in the vehicle seat based on the sensed load value, the occupant sensing system comprising:
load sensing means for sensing a load applied to the vehicle seat as the sensed load value;
load operating means for calculating at least a total load value imposed on the whole vehicle seat, and for calculating a load value applied to a portion of the vehicle seat as a partial load value based on the sensed load value;
load fluctuation operating means for calculating fluctuant quantities based on the total load value and the partial load value as a total load fluctuating quantity and a partial load fluctuating quantity, respectively, and for determining whether or not the total load fluctuating quantity and the partial load fluctuating quantity are on the increase or on the decrease to thereby determine a total load fluctuating direction and a partial load fluctuating direction; and
Occupant-type changeover permission and prohibition determining means for outputting an occupant-type changeover permitting signal indicative of permission of an occupant type changeover only when the total load fluctuating quantity is more than the previously defined first threshold, the partial load fluctuating quantity is more than another threshold different from the first threshold, and the total load fluctuating direction and the partial load fluctuating direction show the same fluctuation tendency.

2. The occupant sensing system according to claim 1, wherein the partial load value includes a front load value applied to the front of the vehicle seat, and a rear load value applied to the rear of the vehicle seat; and
a second threshold and a third threshold different from the first threshold are set as another threshold, the second threshold is less than the third threshold, and the sum of the second threshold and the third threshold is equal to the first threshold; and wherein
the load fluctuation operating means calculates a front load fluctuating quantity corresponding to the front load value and a front load fluctuating direction, and a rear load fluctuating quantity corresponding to the rear load value and a rear load fluctuating direction as a partial load fluctuating quantity; and
the occupant-type changeover permission and prohibition determining means outputs an occupant-type changeover permitting signal indicative of permission of an occupant type changeover only when the total load fluctuating quantity is more than the first threshold, the front load fluctuating quantity and the rear load fluctuating quantity are more than the second threshold and the third threshold, respectively, and the total load fluctuating direction, the front load fluctuating direction, and the rear load fluctuating direction show the same fluctuation tendency.

3. The occupant sensing system according to claim 1, further comprising:
determinant time selecting means for selecting either of a first determinant time and a second determinant time different from each other in response to the occupant-type changeover permitting and prohibiting signal as a selected determinant time; and
occupant-type determining means for determining an occupant type based on the total load value and the previously defined occupant-type threshold to obtain a determined result of the occupant type, and for determining that the occupant type is changed when the determined result of the occupant type lasted over a time period longer than the selected determinant time.

4. The occupant sensing system according to claim 3, wherein the determinant time selecting means selects the first determinant time as the selected determinant time when the occupant type changing signal indicates permission of an occupant type changeover, and selects the second determinant time as the selected determinant time when the occupant type changing signal indicates prohibition of an occupant type changeover; and wherein the first determinant time is shorter than the second determinant time.
